(19) United States
(12) Patent Application Publication
(10) Pub. No.: US 2005/0143680 A1
(43) Pub. Date: Jun. 30, 2005

(54) Arrangement at mounting massage motor

(75) Inventors: Perry Forsberg, Macksta (SE); Joakim Stoor, Kaptensgatan (SE)

Correspondence Address: YOUNG & THOMPSON, 745 SOUTH 23RD STREET, 2ND FLOOR, ARLINGTON, VA, 22202, US

(73) Assignee: HASTENS SANGAR AB, KOPING (SE)

(21) Appl. No.: 10/501,727

(22) PCT Filed: Jan. 15, 2003
(86) PCT No.: PCT/SE03/00053

(51) Int. Cl. A61H 23/02

(52) U.S. Cl. 601/57; 601/59; 601/60

(57) ABSTRACT

An arrangement for fitting a massage motor in a coil spring assembly of a bed, an armchair or the like, wherein the massage motor (3) is fitted inside the coil spring assembly; and wherein the motor (3) is connected to the upper side of at least some of the springs (1) in the coil spring assembly.

The present invention relates to an arrangement for mounting a massage motor in a coil spring assembly of a bed, an armchair or the like.

It is known to use massage motors in beds that include a coil spring assembly, to impart a given massaging effect to the person lying on the bed. In the case of these known motors, the motor is mounted on the existing bed frame on the underside of the bed such that motion of the motor will cause the bed frame to move, and therewith also the springs fitted to the frame, so as to impart a massaging effect to the person lying on the coil spring assembly. Naturally, a large amount of the motion generated by the motor will be lost by virtue of the fact that the whole of the bed frame shall be set into motion. Consequently, propagation of such movement up through the coil spring assembly and the efficiency of the arrangement will be low.

Accordingly, an object of the present invention is to provide a novel massage motor mounting arrangement which enables the efficiency of the massage motor to be significantly enhanced.

This object is achieved with an arrangement in which the massage motor is fitted within the coil spring assembly and connected with the upper side of the springs.

According to one particularly preferred embodiment of the invention movement transmission elements are connected to the massage motor and extends outwardly therefrom to a number of springs, said elements being connected to said springs and functioning to transfer movement from the motor to the springs.

The invention will now be described with reference to a non-limiting embodiment thereof and also with reference to the accompanying drawings, in which

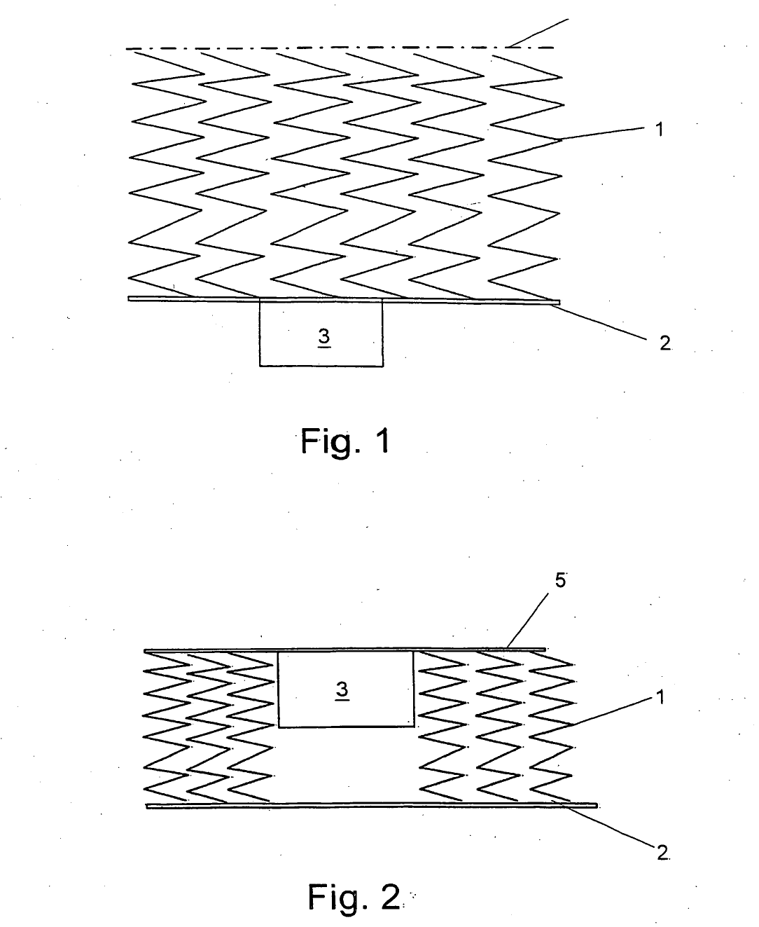

FIG. 1 is a schematic illustration of an interior coil spring assembly to which a massage motor has been fitted in accordance with a known technique;

FIG. 2 is a schematic illustration of an interior coil spring assembly to which a massage motor has been fitted in accordance with the present invention; and

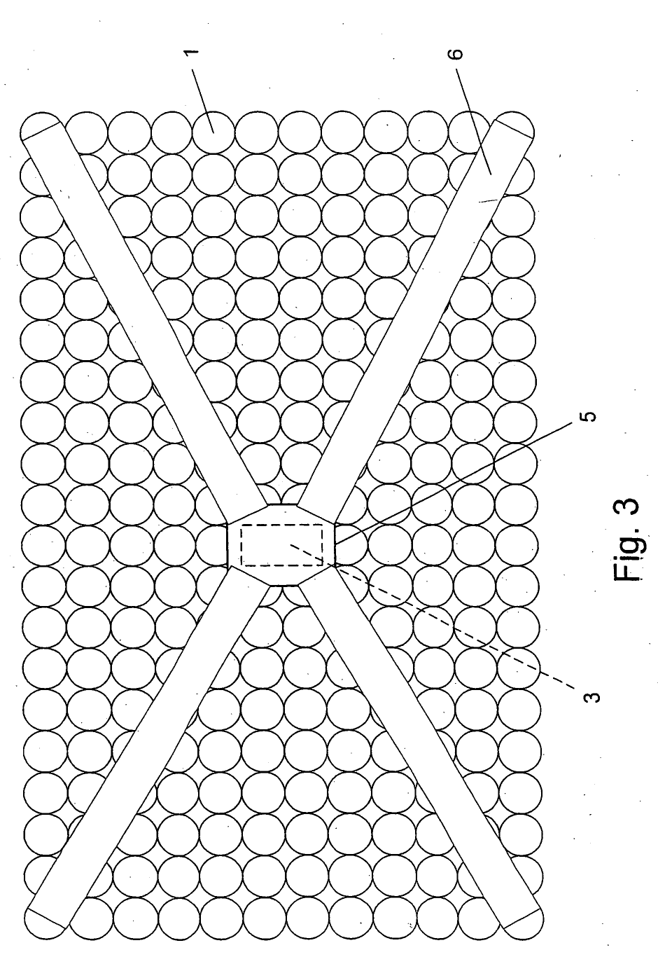

FIG. 3 is a schematic plan view of an interior coil spring assembly to which a massage motor has been fitted in accordance with the invention.

Thus, FIG. 1 is a sectioned view of part of a coil spring assembly that includes a number of mattress springs 1 disposed on a bed frame 2. By mattress springs is meant here coil springs that are housed in separate cloth bags, so-called pocket springs. Fitted to the underside of the bed frame 2 is a massage motor 3, which is a simple imbalanced rotary motor. As the motor 3 rotates, its imbalance is caused to be transmitted to the bed frame therewith also causing the springs 1 fitted to the bed frame to move. This movement is then transmitted through the springs 1 to the surface 4 of the coil spring assembly, so as to massage the person lying on the mattress.

As will be seen from FIG. 2, the inventive arrangement differs from the known arrangement illustrated in FIG. 1 by virtue of the fact that the massage motor 3 is now fitted within the coil spring assembly, between the springs 1, instead of being mounted on the actual bed frame beneath the coil spring assembly, and by virtue of the fact that the motor is fastened in an attachment plate 5 that is connected to the upper part of at least some of the springs 1. Activation of the motor 3 causes the plate 5 to move and therewith immediately influence the upper parts of the springs 1. Motion of the motor 3 is therewith transmitted effectively to that part of the mattress springs 1 that lie closest in contact with the person lying on the mattress.

As before mentioned, FIG. 3 is a plan view of a coil spring assembly which has a massage motor fitted therein in accordance with the invention. It will be seen from the Figure that springs 1 are mounted in a manner to form a generally rectangular coil spring assembly. A pair of springs have been removed, or omitted, from the mattress, roughly in its centre, to provide in said assembly a space in which the massage motor 3 can be fitted. This is also shown in FIG. 2. The motor is mounted on the underside of an attachment plate 5 that is connected to the upper side of at least those springs 1 that nearest surround the motor 3. The motion of the motor is transmitted to the surrounding springs 1, therewith imparting a massaging effect to the person lying on the coil spring assembly.

It will be seen that the FIG. 3 embodiment includes a number of plastic membranes 6 that are connected to the motor 3/the attachment plate 5 and that extend diagonally out to the corners of the coil spring assembly. This provides highly effective spreading of the movement from the motor 3 to the springs 1 in the coil spring assembly. In the case of the illustrated embodiment, the plastic membranes 6 are relatively rigid elements that are connected to those springs 1 that lie beneath the membranes 6.

It will be understood that other types of movement transmission elements may be used instead of said plastic membranes, for instance spring steel wires that extend out from the massage motor 3/the attachment plate 5 to different parts of the coil spring assembly, such as to transmit motion of the motor 3 to a larger number of the springs 1.

The inventive arrangement of the massage motor provides effective transmission of the motion of the motor and a much higher degree of efficiency than hitherto known systems of this nature. Instead of vibrating the entire bed frame, the inventive arrangement solely generates an oscillatory movement in the spring package.

Although the invention has been described with reference to a coil spring assembly for a bed, it will be understood that the concept of the invention can also be applied in other applications in which a number of springs are combined to form a coherent spring pack, for instance in respect of armchairs, settees, automobile seats, etc.

1. An arrangement for fitting a massage motor in a coil spring assembly of a bed, an armchair or the like, characterised in that the massage motor (3) is fitted inside the coil spring assembly; and in that said motor (3) is connected to the upper side of at least some of the springs (1) in the coil spring assembly.

2. An arrangement according to claim 1, characterised in that the massage motor (3) is fitted on the underside of an attachment plate (5) which is fastened to a number of springs (1).

3. An arrangement according to claim 1, characterised in that the massage motor (3) is mounted centrally in relation to the surface of the coil spring assembly, and in that a pair of springs (1) have been omitted to provide room for the massage motor (3).

4. An arrangement according to claim 1, characterised by movement transmission elements (6) connected to the massage motor (3) and extending out from said motor (3) to a number of springs (1), said elements (6) being connected to the springs (1) so as to transmit the movement of the motor (3) to said springs (1).

5. An arrangement according to claim 4, characterised in that the movement transmission element (6) is a strip-like element extending out from the massage motor (3).

6. An arrangement according to claim 5, characterised in that a plurality of strip-like movement transmission elements (6) are disposed to extend from the massage motor (3) to the corners of said coil spring assembly.

7. An arrangement according to claim 4, characterised in that the movement transmission element (6) is comprised of spring steel wires or rods extending out from the massage motor (3).

8. An arrangement according to claim 2, characterised in that the massage motor (3) is mounted centrally in relation to the surface of the coil spring assembly, and in that a pair of springs (1) have been omitted to provide room for the massage motor (3).
